(19) United States
(12) Patent Application Publication
(10) Pub. No.: US 2008/0318083 A1
(43) Pub. Date: Dec. 25, 2008

(54) Super High Strength Stainless Austenitic Steel

(75) Inventors: Hans Berns, Bochum (DE); Valentin G Gavriljuk, Kiew (UA)

Correspondence Address: BUCHANAN, INGERSOLL & ROONEY PC, POST OFFICE BOX 1404, ALEXANDRIA, VA, 22313-1404, US

(73) Assignees: Energietechnik Essen GMBH, Essen (DE); Schaffler KG, Herzogenaurach (DE); KSB AKTIENGESELLSCHAFT, Frankenthal (DE); BOCHUMER VEREIN VERKEHRSTECHNIK GMBH, Bochum (DE); KOPPERN ENTWICKLUNGS GMBH & CO. KG, Hattingen (DE)

(21) Appl. No.: 11/661,973

(22) PCT Filed: Aug. 18, 2005
(86) PCT No.: PCT/EP05/08960

§ 371 Date: Sep. 8, 2008

(30) Foreign Application Priority Data
Sep. 7, 2004 (DE) 10 2004 043 134.5

(51) Int. Cl. B32B 15/18; C22C 38/22; C22C 38/38

(52) U.S. Cl. 428/685; 420/65; 420/57

(57) ABSTRACT

The combined alloying of a CrMnMo steel with carbon and nitrogen creates a stainless austenitic steel of high strength which according to the invention contains (in % by mass) 16-21 Cr, 16-21 Mn, 0.5-2.0 Mo, 0.8-1.1 C+N at a C/N ratio of 0.5-1.1 The steel is subjected to open melting and is suited for uses exhibiting one or more of the following features: strength, ductility, corrosion resistance, wear resistance, non-magnetizability.

The present invention relates to an austenitic steel and to a method for producing the same and to the use of the steel.

The strength of austenitic steels is particularly enhanced by interstitially dissolved atoms of the elements carbon and nitrogen. To dissolve the volatile element nitrogen in the melt, chromium and manganese are above all added to the alloy for reducing nitrogen activity. While chromium alone prompts the formation of ferrite, an austenitic structure can be adjusted with manganese by solution annealing and can be stabilized by quenching in water up to room temperature. The influence of carbon and nitrogen is illustrated by way of an iron alloy having 18% by mass of chromium and 18% by mass of manganese in FIG. 1 with the help of calculated phase diagrams. The calculation is based on thermodynamic substance data that are compiled from the literature in databases and processed for illustrating phase equilibriums, “Thermo-Calc, User's Guide, Version N, Thermo-Calc Software AB, Stockholm Technology Park, Stockholm”.

As can be seen from FIG. 1a, there is no homogeneous austenite at 1% by mass of C. Chromium-rich carbides prevent an adequate passivation of the matrix, so that the steel Cr18Mn18C1 (the composition is here based on % by mass) does not count among the stainless steels despite the high chromium content. If carbon is replaced by nitrogen, a homogeneously austenitic stainless steel structure is obtained by solution annealing at e.g. 1100° C., as shown in FIG. 1. The plotted equilibrium air pressure p_{L} of 1 bar reveals that the melt absorbs about 0.55% by mass of nitrogen, which however tends to outgas in the primarily ferritic solidification. Therefore, without an increase in pressure it is actually not possible to achieve a content of 1% by mass of nitrogen in the austenite. In a steel having 1% by mass of carbon, this problem regarding pressure dependence does not arise.

As shown in FIG. 1a, the development of stainless austenitic steels having a high strength by interstitial atoms is defined by the lack of solubility of carbon in the austenite and is limited according to FIG. 1b by the lack of solubility of nitrogen in the melt under normal atmospheric pressure.

Different approaches are known for overcoming this limit. One approach refers to the simultaneous use of chromium and manganese, (Cr+Mn) approach. The content of the solubility-promoting elements chromium and manganese is here raised to such an extent that up to 1% by mass of nitrogen can be dissolved under atmospheric pressure in the melt and in the austenite. Reference is here made to steel A in the subsequent Table 1. To avoid nitride precipitations, the solution annealing temperature must be raised to about 1150° C. A further drawback is the limitation of the forging temperature range and the risk of edge cracks during hot forming.

Another approach comprises the simultaneous addition of carbon and nitrogen, (C+N) approach, as is e.g. indicated in B. D. Shanina, V. G. Gavriljuk, H. Berns, F. Schmalt: Steel research 73 (2002)3, pages 105-113. The increase in the concentration of free electrodes in the austenite lattice by simultaneous dissolution of carbon and nitrogen is here exploited. This stabilizes the austenite, i.e. the range of solubility is increased for interstitial elements. Since the nitrogen is partly replaced by carbon, its outgassing from the melt can be avoided in the case of a reduced chromium and manganese content as is required according to the (Cr+Mn) approach. So far a CrMn steel with a (C+N) content of about 0.8% by mass has been molten according to the (C+N) approach under atmospheric pressure; cf. steel B of the subsequent Table 1. Steels C and D according to the following Table 1 must also be assigned to this group.

TABLE 1

| Steel | Cr | Mn | C | N | Others |
|---|---|---|---|---|---|
| A | 21 | 23 | <0.1 | 0.9 | 0.7 Mo |
| B | 14.7 | 17.2 | 0.39 | 0.43 | — |
| C | 12.9 | 19.3 | 0.38 | 0.49 | — |
| D | 19.2 | 18.4 | 0.5 | 0.54 | 0.5 Ni |

Among the open-melted steels having a high interstitial content it is not possible to find CrNi steels because nickel, just like silicon, reduces the solubility for carbon and nitrogen. The R_{p0.2} yield strength of the standard steel of this group X5CrNi18-10 is about 220 MPa. The known chromium-manganese steels achieve more than twice the value. In addition they have a high true break strength R, which is due to a strong work hardening with a correspondingly large uniform elongation A_{g}. This work hardening ability is also the reason for the high wear resistance of said high-strength austenitic steels.

Further known corrosion-resistant austenitic steels shall briefly be mentioned in the following:

A known chromium-manganese steel is e.g. described in CH 202283. The chromium-manganese steel comprises 0.01-1.5% carbon, 5-25% chromium and 10-35% manganese, and a nitrogen content of 0.07-0.7%. However, it becomes apparent from the enclosed table that according to this disclosure both carbon and nitrogen are rather used in the lower range of the indicated amount and that adequately good results are already achieved thereby.

Furthermore, U.S. Pat. No. 4,493,733 discloses a corrosion-resistant non-magnetic steel comprising 0.4% or less of carbon, 0.3-1% nitrogen, 12-20% chromium, 13-25% manganese and less than 2% silicon. Furthermore, the steel according to the indicated composition may contain up to 5% molybdenum. In this instance, too, it becomes particularly apparent from the table that a carbon content that is as low as possible is preferred for achieving good properties of the finished steel.

A further austenitic corrosion-resistant alloy is known from EP 0875591, said alloy being particularly used for articles and components that get into contact with living beings at least in part. The alloy comprises 11-24% by wt. of Cr, 5-26% by wt. of Mn, 2.5-6% by wt. of Mo, 0.1-0.9% by wt. of C, and 0.2-2% by wt. of N. Special emphasis is placed on increased carbon contents and is based on the finding that carbon in solid solution enhances the resistance to crevice corrosion of austenitic stainless steels in acid chloride solutions.

Furthermore, DE 19513407 refers to the use of an austenitic steel alloy for articles compatible with the skin, the steel alloy comprising up to 0.3% by mass of carbon, 2-26% by mass of manganese, 11-24% by mass of chromium, more than 2.5-5% by mass of molybdenum, and more than 0.55-1.2% by mass of nitrogen, the balance being iron and unavoidable impurities. It is here stated with respect to the carbon amount that even slightly increased carbon contents adversely affect the resistance to corrosion or to stress corrosion cracking, and the carbon content should therefore be as small as possible, preferably less than 0.1% by mass.

It is the object of the present invention to provide a corrosion-resistant austenitic steel that is characterized by high resistance to corrosion and by particularly high strength and wear resistance.

This object is achieved by a stainless austenitic steel having the following composition, in % by mass: 16-21% chromium, 16-21% manganese, 0.5-2.0% molybdenum, a total of 0.80-1.1% carbon and nitrogen, and having a carbon/nitrogen ratio of 0.5-1.1, the balance being iron, and a total content of ≦2.5% of impurities caused by the melting process.

The steel according to the invention is distinguished by a particularly high strength and good corrosion resistance in very different environments and thus offers a great number of possible applications. Moreover, the steel can be produced at low costs, so that it is suited for very different uses, particularly also for applications where corresponding steels have so far not been used for reasons of costs.

The steel of the invention starts from the (C+N) approach, but extends said approach. For instance, the interstitial alloy content of the homogeneous austenite is set to 0.80-1.1% by mass of carbon and nitrogen to achieve a high degree of yield strength, break strength and wear resistance. According to the invention the carbon/nitrogen mass ratio is set to a range between 0.5 and 1.1 to permit melting of the steel under normal atmospheric pressure of about one bar and its hot forming within a wide temperature range of the homogeneous austenite.

In contrast to the known prior art, it is possible to dissolve a high interstitial content with open melting in the steel by observing a carbon/nitrogen ratio, thereby achieving excellent strength characteristics without the need for limiting the forging range or for raising the substituted alloy content, as is the case with steels that are melted under atmospheric pressure and are given a high strength solely by nitrogen. In addition, the drawback of a low resistance to corrosion of CrMn steels, as compared with CrNi steels, is already compensated by a small Mo addition which in combination with N ensures the resistance to corrosion as is required for the intended use.

According to a preferred embodiment of the invention the total content of carbon and nitrogen is 0.80-0.95% by mass. In other embodiments a total content of carbon and nitrogen of 0.95-1.1% by mass has turned out to be useful. Thanks to the adjustment of the total content of carbon and nitrogen, the yield strength can directly be varied and the composition of the steel can thus be adapted to the desired use.

According to a further preferred embodiment the content of molybdenum is 0.5-1.2% by mass. Workpieces made from a steel having the indicated molybdenum content have turned out to be particularly suited for an application in which the workpieces are subject to atmospheric corrosion.

Advantageously, the molybdenum content may amount to more than 1.2-2.0% by mass. A corresponding molybdenum content is particularly suited for workpieces made from steel, which during use are exposed to corrosion by halide ions.

According to a further preferred embodiment, it may be that the content of nickel as an impurity caused by the melting process is less than 0.2% by mass. Ac correspondingly produced steel can particularly be used for workpieces which are temporarily in contact with the human body.

Advantageously, the corrosion-resistant austenitic steel can be subjected to open melting, i.e. under normal atmospheric pressure of about 1 bar. Thanks to this open melting the production costs are inter alia reduced considerably.

According to a further preferred embodiment the 0.2 yield strength after the dissolution process can exceed 450 MPa and in another embodiment it can exceed 550 MPa. Hence, the steel can be adapted through the selected composition to the properties demanded for the desired future use.

Advantageously, the steel of the invention can be used for producing high-strength, stainless, wear-resistant and/or non-magnetizable workpieces.

Furthermore, the present invention provides a method for producing a corrosion-resistant austenitic steel having the above-mentioned composition, by melting under atmospheric pressure of about 1 bar and subsequent shaping.

Since the steel can be produced and processed in conventional method steps, no additional apparatus is here needed for producing the steel of the invention.

Advantageously, the shaping process is selected from the group consisting of casting, powder metallurgy, forming and welding. It becomes apparent that the most different shaping processes can be used for giving the steel the desired shape, so that it is here also possible to form the most different workpieces.

Advantageously, the steel can be applied as a layer onto a metallic substrate.

Furthermore, the present invention relates to the use of the steel of the invention as wear-resistant workpieces for obtaining and processing mineral articles and for using them up in building.

According to a further embodiment the steel may be used for non-magnetizable cap rings, which can be work-hardened, in electric generators.

Advantageously, the steel of the invention can be used for non-magnetizable rolling bearings that can be work-hardened and used in the vicinity of strong magnetic fields.

According to a further advantageous embodiment the steel of the invention can be used for non-magnetizable frames or mounts of strong magnetic coils for absorbing the mechanical forces.

According to a still further embodiment, the inventive steel can be used by virtue of its high plastic forming capacity for components that consume the arising impact energy by plastic deformation. Corresponding components are particularly suited for use during collision of vehicles.

A preferred embodiment of the present invention will now be explained in more detail with reference to a drawing, in which:

FIG. 1 a is a calculated phase diagram for a known steel having 18% by mass of Cr and 18% by mass of Mn, which is alloyed with carbon;

FIG. 1 b is a calculated phase diagram for a known steel having 18% by mass of Cr and 18% by mass of Mn, which is alloyed with nitrogen;

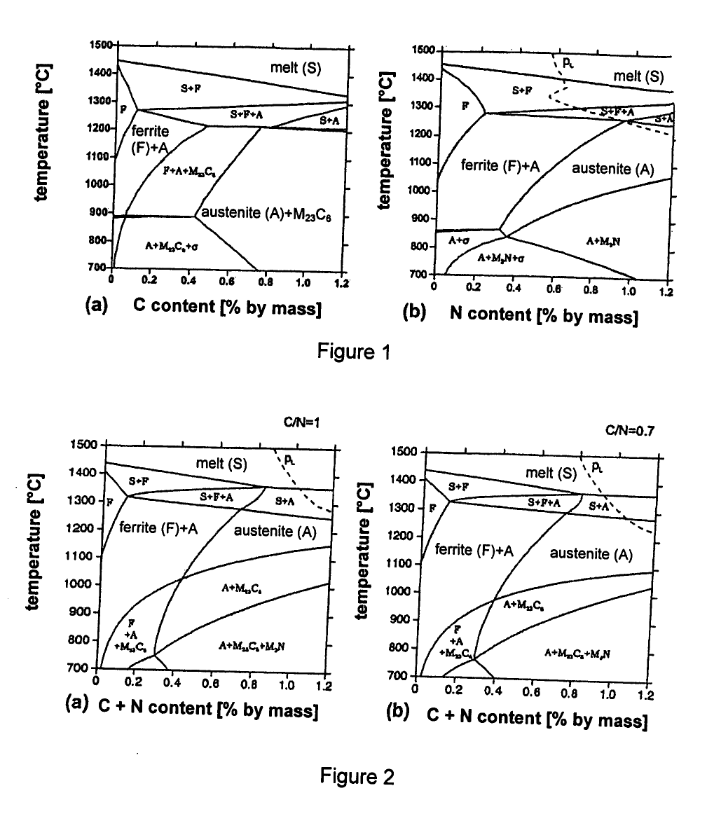

FIG. 2 a is a calculated phase diagram for a steel of the invention having 18% by mass of Cr and 18% by mass of Mn and also carbon and nitrogen, the carbon/nitrogen ratio being 1,

FIG. 2 b is a calculated phase diagram for a steel of the invention having 18% by mass of Cr and 18% by mass of Mn, and also carbon and nitrogen, the carbon/nitrogen ratio being 0.7.

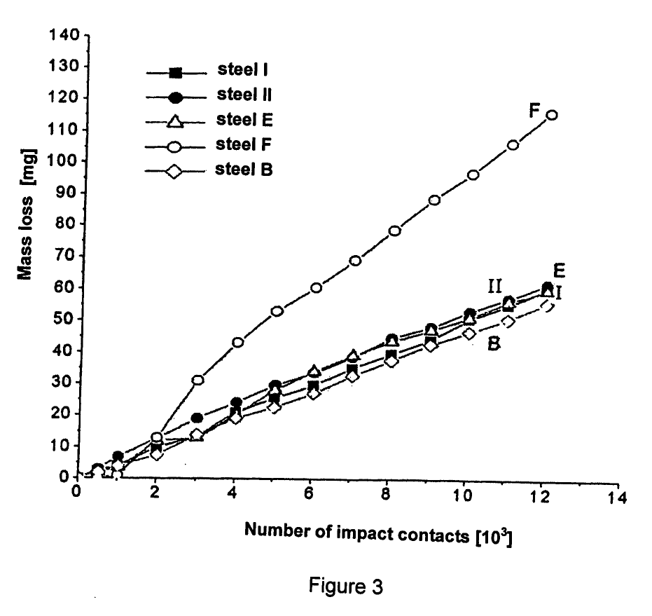

FIG. 3 shows the results of the mass removals determined in the impact wear test, for the analyzed austenitic steels.

FIG. 2 shows the effect of the C/N mass ratio on the equilibrium state by way of an example of a steel having 18% by mass of chromium and 18% by mass of manganese. The pressure line in FIG. 2 a indicates that the melt at C/N=1 can absorb about 1% by mass of C+N, which leads to homogeneous austenite at a solution annealing temperature of 1150° C. Likewise, FIG. 2 b reveals that at C/N=0.7 about 0.9% by mass of C+N can be absorbed by the melt and that a solution annealing temperature of 1100° C. is enough for setting homogeneous austenite. In comparison with FIG. 1 it becomes apparent that a high solubility of said elements is achieved in both the melt and the austenite by simultaneous alloying with C+N.

When the substituted alloying content is 16-21% by mass for chromium and for manganese, the necessary solubility for nitrogen is achieved and the austenite is stabilized. With 0.5-2% by mass of molybdenum the corrosion resistance (particularly to pitting corrosion by chloride ions) is improved, said resistance being normally lower for CrMn austenite than for CrNi austenite. A synergistic effect of N+Mo is here exploited, which yields a noticeable improvement already at 0.5% by mass of Mo. Molybdenum contents of more than 2% by mass narrow the forging range again and are therefore excluded.

The chemical composition of two variants I and II of the steel of the invention is shown in the following Table 2. Its fusion and casting into blocks is carried out in the open in air under atmospheric pressure of about 1 bar. The blocks were rolled in heat into steel bars without the occurrence of cracks or other flaws. The further hot forming by forging to smaller sample dimensions also took place without any flaws.

The further steels indicated in Table 2 are conventionally obtainable steels, i.e. steel E is a manganese hard steel X120Mn12 which is not resistant to corrosion, and steel 11 is a stainless CrNi steel X5CrN18-10.

TABLE 2

Composition

| Steel | Cr | Mn | Ni | Mo | C | N |
|---|---|---|---|---|---|---|
| I | 18.8 | 18.9 | 0.4 | 0.6 | 0.49 | 0.58 |
| II | 18.2 | 18.9 | 0.3 | 0.7 | 0.35 | 0.61 |
| E | 0.17 | 12.06 | 0.13 | — | 1.19 | 0.001 |
| F | 18.67 | 1.91 | 9.04 | — | 0.004 | 0.05 |

The mechanical properties determined in the tensile test according to DIN EN 100021 at room temperature for the two steels of the invention shown in Table 2 are illustrated in Table 3 and are compared with those of the stainless austenitic standard steel (F)=X5CrN18-10 and of the wear-resistant manganese hard steel (E)=X120Mn12 which is austenitic but not corrosion-resistant. Steel B is a weakly corrosion-resistant test alloy. Variants I and II according to the invention are clearly superior to the comparative steels in terms of yield strength and tensile strength.

TABLE 3

| | Steel | | | | |
|---|---|---|---|---|---|
| | I | II | B | E | F |
| R_{p0.2} (MPa) | 604 | 600 | 494 | 370 | 221 |
| Rₘ (MPa) | 1075 | 1062 | 951 | 829 | 592 |
| R (MPa) | 2545 | 2547 | 2635 | 1131 | 1930 |
| A_{g} (%/0) | 62 | 61 | 68 | 45 | 70 |
| A₅ (%) | 73.5 | 73.5 | 78 | 46 | 83 |
| Z (%) | 52.0 | 68.7 | 68 | 33 | 86 |
| R_{p0.2} × Z/10⁴ | 3.14 | 4.12 | 3.35 | 1.22 | 1.90 |

FIG. 3 shows the resistance to impact wear. Sample plates attached to two arms of a rotor were hit vertically by particles of broken graywacke with a sieve size of 8 to 11 mm and at a relative speed of 26 m/s. The mass loss is plotted versus the number of particle contacts and shows that the variants of the invention are equal to the non-corrosion resistant manganese hard steel, but clearly beat the stainless standard steel F.

Variants I and II also remain non-magnetizable after plastic deformation in the impact wear test, which is expressed in the low relative magnetic permeability μᵣₑₗ=1.0012, which was measured with a commercially available permeability sensor provided for this purpose on the impact wear surface. For the manganese hard steel E, μᵣₑₗ=1.0025. The stainless standard steel achieves μᵣₑₗ=1.1 due to the formation of deformation martensite and is thus weakly magnetizable.

In the permanent immersion test according to DIN 50905 Parts 1 and 2, variants I and II of the invention were not attacked in an aqueous solution with 1% by mass of H₂SO₃ at pH=2 and room temperature for 120 h. Acid mine water in a mine was imitated with the test solution. By contrast, the manganese hard steel E that had so far been used showed a clear mass loss by corrosion, as follows from Table 4. Although the stainless standard steel F turns out to be resistant, it is not suited for operational use due to its low resistance to wear. The break-through potentials for beginning crevice corrosion according to Table 4 follow from the determination of current density-potential curves according to DIN 50918 in aqueous solution with 3% by mass of NaCl. They suggest that the resistance of variants I and II of the invention is superior to that of the standard steel in seawater.

TABLE 4

| | Steel | | | | |
|---|---|---|---|---|---|
| | I | II | B | E | F |
| Mass loss | 0 | 0 | 0.33 | 1.56 | 0 |
| rate (g/m²h) in | | | | | |
| 1% H₂SO₃ | | | | | |
| Break- | 700 | 750 | 100 | — | 480 |
| through | | | | | |
| potential | | | | | |
| (mV) in 3% NaCl | | | | | |

Thanks to the expansion of the C+N approach the steel of the invention can be produced at low costs, i.e. open melting without pressure or powder metallurgy, and achieves an excellent combination of mechanical, chemical, tribological and physical properties. This yields, in particular, the following examples of use for the steel according to the invention.
(a) Crushing tools in a mine are exposed to corrosive mine water at a slightly increased temperature and require high yield strength and wear resistance in addition to corrosion resistance.
(b) Cap rings as a mount for winding ends in power station generators are cold-expanded to a high yield strength and must be non-magnetic and must not corrode during operation.
(c) Rolling bearings in the vicinity of superconducting magnets must be of a high strength, non-magnetizable and often also stainless.
(d) Strong magnets exert great forces that must be held by non-magnetizable solid frames. Like in (a), mold casting offers an inexpensive manufacture.
(e) Force x displacement defines the break work in the tensile test. The high yield strength, work hardening and elongation after fracture give the steel of the invention an extraordinary high forming capacity which can be used for consuming impact energy, such as the one arising in a vehicle crash.
(f) To avoid nickel allergies, nickel-free stainless austenitic steels are useful for medical engineering.

1. A corrosion-resistant austenitic steel having the following composition, in % by mass:
16-21% chromium
16-21% manganese
0.5-2.0% molybdenum
a total of 0.80-1.1% carbon and nitrogen,
and having a carbon/nitrogen ratio of 0.5-1.1,
the balance being iron, and a total content of ≦2.5% of impurities caused by the melting process.

2. The corrosion-resistant austenitic steel according to claim 1, wherein the total content of carbon and nitrogen is 0.80-0.95% by mass.

3. The corrosion-resistant austenitic steel according to claim 1, wherein the total content of carbon and nitrogen is 0.95-1.1% by mass.

4. The corrosion-resistant austenitic steel according to claim 1, wherein the content of molybdenum is 0.5-1.2% by mass.

5. The corrosion-resistant austenitic steel according to claim 1, wherein the content of molybdenum is 1.2-2.0% by mass.

6. The corrosion-resistant austenitic steel according to claim 1, wherein the content of nickel as the melt-induced impurity is less than 0.2% by mass.

7. The corrosion-resistant austenitic steel according to claim 1 which is meltable under normal atmospheric pressure of about 1 bar.

8. The corrosion-resistant austenitic steel according to claim 2, wherein the 0.2 yield strength after solution annealing exceeds 450 MPa.

9. The corrosion-resistant austenitic steel according to claim 3, wherein the 0.2 yield strength after solution annealing exceeds 550 MPa.

10. The corrosion-resistant austenitic steel according to claim 1 which is used for producing high-strength, stainless, wear-resistant and/or non-magnetizable workpieces.

11. The corrosion-resistant austenitic steel according to claim 1, comprising X5OCrMn19-19.

12. The corrosion-resistant austenitic steel according to claim 1, comprising X35CrMn18-19.

13. A method for producing a corrosion-resistant austenitic steel having the following composition, in % by mass:
16-21% chromium
16-21% manganese
0.5-2.0% molybdenum
a total of 0.80-1.1% carbon and nitrogen,
and having a carbon/nitrogen ratio of 0.5-1.1,
the balance being iron, and a total content of ≦2.5% of impurities caused by the melting process
by melting under atmospheric pressure of about 1 bar and subsequent shaping.

14. The method for producing a corrosion-resistant austenitic steel according to claim 13, wherein shaping is selected from the group consisting of casting, powder metallurgy, forming and welding.

15. The method for producing a corrosion-resistant austenitic steel, according to claim 13, wherein the steel is applied as a layer onto a metallic substrate.

16. Use of the corrosion-resistant austenitic steel according to claim 1 as wear-resistant workpieces for obtaining and processing mineral articles and for using them up in building.

17. Use of the corrosion-resistant austenitic steel according to claim 1 for non-magnetizable cap rings which can be work-hardened and are used in electric generators.

18. Use of the corrosion-resistant austenitic steel according to claim 1 for non-magnetizable rolling bearings which can be work-hardened and are used in the vicinity of strong magnetic fields.

19. Use of the corrosion-resistant austenitic steel according to claim 1 for non-magnetizable frames or mounts of strong magnetic coils for absorbing the mechanical forces.

20. Use of the corrosion-resistant austenitic steel according to claim 1 for components having a great forming capacity for energy consumption by plastic deformation.

21. Use of the corrosion-resistant austenitic steel produced according to the method of claim 13 as wear-resistant workpieces for obtaining and processing mineral articles and for using them up in building.

22. Use of the corrosion-resistant austenitic steel produced according to the method of claim 13 for non-magnetizable cap rings which can be work-hardened and are used in electric generators.

23. Use of the corrosion-resistant austenitic steel produced according to the method of claim 13 for non-magnetizable rolling bearings which can be work-hardened and are used in the vicinity of strong magnetic fields.

24. Use of the corrosion-resistant austenitic steel produced according to the method of claim 13 for non-magnetizable frames or mounts of strong magnetic coils for absorbing the mechanical forces.

25. Use of the corrosion-resistant austenitic steel produced according to the method of claim 13 for components having a great forming capacity for energy consumption by plastic deformation.
